(19) United States
(12) Patent Application Publication
(10) Pub. No.: US 2008/0264581 A1
(43) Pub. Date: Oct. 30, 2008

(54) Structures for efficient use of veneer

(76) Inventor: Han-Sen Lee, Chang-Hwa Hsien (TW)

Correspondence Address: Harrington & Harrington;Curtis L. Harrington, Suite 250, 6300 State University Drive, Long Beach, CA, 90815, US

(21) Appl. No.: 11/799,494

(22) Filed: Apr. 30, 2007

(51) Int. Cl. E06B 3/10

(52) U.S. Cl. 160/236

(57) ABSTRACT

The structures and process for producing the structures of the invention enable extensive and efficient use of veneer and bamboo veneer for slat manufacturing. The techniques employed advantageously accomplish two goals simultaneously, a reduced volume of slat material to reduce the load on the internals of a horizontal blind set, and the provision of a more inexpensive but higher quality long lasting slat outward appearance. One or more core materials made of woven and non-woven and preferably fibrous cloth, as well as combining with metal and other structural layers, are combined with veneers and bamboo veneer to yield a very lightweight slat with good structural characteristics.

### FIELD OF THE INVENTION

The present invention relates to production methods and products which utilize veneer in a manner that will provide a superior, natural product, especially for window covering components, including slats and methods for construction, to enable the construction of a high quality, consistent louver product which may be trimmed to fit a custom window opening.

### BACKGROUND OF THE INVENTION

Slats are utilized in a variety of window coverings, including Venetian blinds, and vertical blinds. Slats have in the past been constructed of thin metal from rolls, curved along the path of their shorter dimension to produce a break through stiffness, holding stiff unless stressed. Other slats use thicker materials, typically flat elongate members. These slats include relatively thicker structures whose stiffness is similar to that of a ruler. Modern materials have enabled the construction of slats having a wide variety of strength and size, and other attributes associated with the materials from which they were constructed.

Two opposing developing factors are causing new construction methods to be sought. The first factor is the increasing scarcity of materials, both structural and decorative. The second factor is a driving need to have an ever more custom appearance for interior finishings. In terms of materials generally, the price continues to increase. Plain ordinary unfinished wood is increasing in cost and becoming more scarce. High quality wood for producing a high quality wood finish is even more expensive. Synthetic materials which are carbon based continue to rise in price.

Another aspect of the use of materials in window coverings involves elimination of material volume while allowing the same look as could be achieved in using whole natural materials. Veneers and veneer techniques have long been employed in furniture and furniture making. The veneer technique enables the use of a thin layer of a high quality material which is laminated, glued or affixed to a less expensive structural support to give the impression that the whole member is made solidly of the higher quality material.

Veneer is good for solid furniture structures as it tends to splinter and crack with nearly any movement of the supporting substrate to which it is attached. The use of veneer with less substantial support substrates can readily result in cracking, splintering and friability. Veneers used to date with window covering materials, particularly horizontal blind slats, have been limited to being used with thick slats which are so thick and rigid that bending will not substantially occur.

The use of thick slats has a number of its own associated problems. Thicker slats are more expensive because of the sheer volume of material used. For high ceilings or vertically tall windows, thicker slats create significant weight problems. Thicker slats collected at the top of the window opening create a vertically wider block and inhibit the amount of open space which the blind set can created by being vertically raised.

Heavier components create an even greater and unseen problem. The total weight on the vertical array of horizontal blinds causes greater friction on the lifting components. Greater friction causes failure in each of the components affected. This includes the lift cord, the lift cord wear member where the cord leaves the head rail, a locking mechanism which is used to selectively lock the lift cord, the lift cord contact inside the head rail, and the angular fittings at the point where the lift cords turn down through the head rail. Component parts can wear and fray and thus increase the wear and fray on the lift cords. In some cases this creates an avalanche of wear in which wear on a component causes the lift cord to go from normal condition to rapid wear and failure.

Weight related wear will in essence destroy the value of the window covering. Worn cord fitting replacement involves the removal of the window covering and a complete re-working of the internal components, as well as a re-threading of the louvers and base slat. Many of the components depend upon the apertures and other support structures which were in existence at the time of manufacture, all of which change from time to time. As a result, a failure in a window covering set will likely render it worthless. The alternative of having someone create parts which are long since obsolete and commercially not available is so expensive that it would be less expensive to simply replace the window covering set.

Replacement of this type creates additional waste. Even where the window covering is of high quality it will be less expensive to buy a new, integrated window covering set. Where a single matched window covering fails, and becomes beyond repair, all of the window coverings in a room will likely be replaced in order to maintain the aesthetic balance. The result is that the failure rate of a window covering is of the type which creates significant, related waste.

Therefore, the need to reduce the failure rate in a window covering set is acute and has significant effect. The reduction of slat weight is one of the most critical contributors to increasing the life of window covering sets, particularly horizontal blind sets, over time. Lesser slat weight translates into lesser wear for lift cords and the fittings in a horizontal blind set.

The variety available for light weight slats have been limited to thin metal having a non-aesthetic look. Further, the use of raw metal slats or painted slats subjects them to being scratched or scored, thus permanently marking them. Raw or painted metal slats lack the resilience and repair ability of wood. Resilience and mark resistance can be had via an outer lacquer coat to reduce friction and the ability to produce scratches, as well as the ability to use wood repair techniques and stains to repair any scratches and the like.

What is therefore needed is the ability to produce slats having extreme light weight and also a repairable wood finish. The needed slat should be resilient, have the ability to assume a variety of shapes and also be amenable to cutting in order to form custom widths.

### SUMMARY OF THE INVENTION

The structures and process for producing the structures of the invention enable extensive and efficient use of veneer and bamboo veneer for slat manufacturing. The techniques employed advantageously accomplish two goals simultaneously, a reduced volume of slat material to reduce the load on the internals of a horizontal blind set, and the provision of a more inexpensive but higher quality long lasting slat outward appearance. One or more core materials made of woven and non-woven and preferably fibrous cloth, as well as combining with metal and other structural layers, are combined with veneers and bamboo veneer to yield a very lightweight slat with good structural characteristics.

The technique enables scrap, such as block scrap, to be formed into longer effective lengths. Such longer effective lengths can then be cutably formed into slats of various sizes. The joinder of the block scrap is by deeply extending, finite interlock length finger joints which, once the material is cutably formed into slats, remain as relatively shallow (the thickness of the slat) and finite interlock length finger joints. The joints have the added benefit that they statistically “break up” any grain differences which would otherwise create warp, and enable long lengths of slat to be employed from several shorter lengths of scrap. The utilization of multiple sets of finger joints virtually completely eliminates the tendency to warp, and provides additional strength against twist forces. Further, as an added economic benefit above and beyond the benefits already mentioned, the technique not only enables waste normally occurring in slat manufacture to be saved, but actually encourages the manufacture of a superior quality product by encouraging lower cost scrap to be used as the primary resource in the manufacturing process. In other words, longer lengths of higher priced wood can be used elsewhere in products where grain structure and uninterrupted length is necessary, and thus drive down the costs in those industries, while at the same time enabling slat construction almost exclusively from scrap.

To further utilize scrap wood and to further reduce waste, adjacent narrower widths of wood can be utilized in combination with wider lengths of wood at the finger joint to enable two or more widths of wood material to function as if they were a single width of material. When securely glued, both at the finger joint as well as along the lengths of more narrow material, the resulting slats have as much strength as slats formed from a whole length of wood material. Even where the narrow lengths of wood have a linear, thin, glued interface, superior strength bending and twist resistance is observed.

A technique for covering the constructed slat with a layer of paper, especially paper bearing a wood grained pattern, followed by use of a gluing material of, for example vinyl acetate resin, followed by providing a clear and appropriately surface finish varnish, preferably of ultraviolet resistant material can produce a slat which has an appearance exactly as if it were formed from a single length of wood material.

### BRIEF DESCRIPTION OF THE DRAWINGS

The invention, its configuration, construction, and operation will be best further described in the following detailed description, taken in conjunction with the accompanying drawings in which:

FIG. 1 illustrates a perspective exploded view of the end of a short length of slat material with exploded lacquer layer with two layers of veneer surrounding a core layer;

FIG. 2 illustrates a perspective exploded view of the end of a short length of slat material with exploded lacquer layer with two layers of veneer surrounding a pair of inner layers;

FIG. 3 illustrates a perspective exploded view of the end of a short length of slat material with exploded lacquer layer with a layer of upper veneer and an underlying layer attached to it for support;

FIG. 4 is illustrates a perspective exploded view of the end of a short length of slat material with exploded lacquer layer with two layers of veneer surrounding a set of three inner layers which may be any type of layer but preferably a center scrap veneer layer surrounded by two cloth or non-woven layers;

FIG. 5 is a plan view of the end of a bamboo embodiment of the composite slats shown in FIGS. 1-4, but emphasizing the generally uniform lateral profile of bamboo assemblies as one possible overall layout as might be seen from the formation of a slat according to the invention utilizing bamboo strips;

FIG. 6 is an end view of a curved slat having a core layer to illustrate that the technique of the invention can be used for producing curved slats; and

FIG. 7 is an end view showing a technique in which one or any number of core layers terminate short of the full extent of the width of veneer layers to enable the veneer layers to attach to each other and form a double thickness, shapable, otherwise finely finish able curved edge termination.

### DETAILED DESCRIPTION OF THE PREFERRED EMBODIMENT

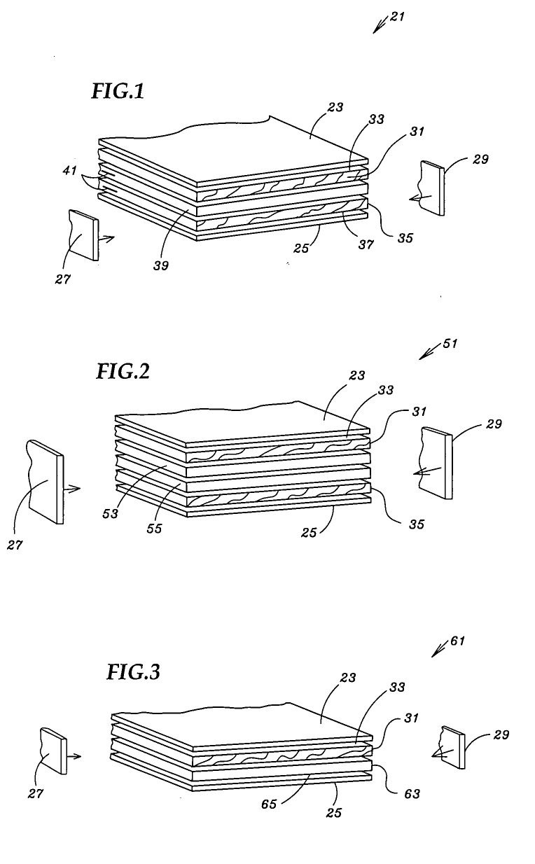

The description and operation of the veneer system and method of the invention will begun to be best described with reference to FIG. 1 which illustrates an end perspective exploded view of the end of a short length of slat 21 shown in extreme detail. From the outermost perspective, the slat 21 is covered and surrounded with a layer of lacquer, typically an acrylic, typically a UV resistant and UV cured material to seal the components within. As seen in exploded view, the layer of lacquer includes an upper layer 23, lower layer 25, left side layer 27 and right side layer 29. The lacquer is typically sprayed on and thus envelops the entire assembled slat 21. The lacquer layers 23, 25, 27, and 29 completely surround and envelop the slat 21 continuously and may be expected to occur at the ends, such as into the face directed toward the viewer in FIG. 1, as is necessary to seal all layers within the slat 21.

The lacquer layers 23, 25, 27, and 29 will preferably resist ultraviolet radiation degradation, and may include a simple lacquer, a poly resin, polyester or acrylic. The lacquer layers 23, 25, 27, and 29 are shown exploded and schematic, but this is a crude representation of the annular surrounding nature and the annular sealing nature which the lacquer layers 23, 25, 27, and 29 provide to the more internal layers. Sealing is important as it shuts out moisture and makes the resulting slat 21 (as well as all of the slats shown in subsequent Figures) stronger and more mark resistant.

This is not to imply necessarily that the lacquer layers 23, 25, 27, and 29 make a shiny or even flat finish. Where the finished surfaces 33 and 37 are roughened, the lacquer layers 23, 25, 27, and 29 may preferably be thin enough to enable the roughened surface to express itself through the lacquer. As such, the selection of the viscosity of the lacquer layers 23, 25, 27, and 29 can effect the outside surface characteristics. A roughened appearance can do more for light dispersal than a simply flat-color appearance, particularly a low light angle incidence.

Within the slat 21 seen in FIG. 1 is an upper veneer layer 31 having an upper finished surface 33 and a lower veneer layer 35 having a lower finished surface 37 (indicated but not seen). Since the lacquer layers 23, 25, 27, and 29 are typically extremely thin and transparent, the veneer layers 31 and 35, and their finished surfaces 33 and 37 will form the visual impression of the resulting surface color and texture of the slat 21. A bonding core layer 39 is provided to which the veneer layers 31 and 35 are attached along their main surfaces opposite their finished surfaces 33 and 37. A layer of glue or adhesive 41 is also shown for completeness, and only over a rear portion of the slat 21 and will not be shown further, although such layer of flue or adhesive 41 may exist between any of the layers shown for the invention.

The dimensions for the components shown in FIG. 1 will be discussed. The purpose of the invention is to provide a wood finish through the use of veneer, to produce an ultra thin slat 21 which is very light, but has a substantial appearance in terms of its color and texture. The upper and lower veneer layers 31 may have a thickness of from about 0.2 mm to about 0.6 mm with the most preferable being veneer thickness nearer the 0.2 side of the thickness scale, limited only by the need to have a minimum thickness which will (1) not become transparent enough to transmit any light from the bonding core layer 39 and (2) will not be so thin where it is desired to show and present a pattern having three dimensional variance, such as deep grain, where the deepest grain might otherwise form an opening to the bonding core layer 39.

The bonding core layer 39 may be any of a variety of materials. A few of the materials may include a non-woven material or woven material, cloth, glass, carbon composite, wood, wood veneer, woven wood veneer, cross grain ply-veneer or ply-veneer, or metal.

The term “woven wood veneer” may refer to a woven pattern of veneer strips having a main length parallel to the grain of the wood. Having such strips woven into a crossing matrix can increase the strength of the woven pattern. There is very little overall difference between woven veneer and a woven cloth except for the size and longitudinal grain of the material. A finely subdivided very thin material approaches a structure similar to cloth. Most woven materials exist as groups of fibers rather than individually cris-crossing to make up the cloth. Many woven materials have significant lateral friction and can have various degrees of cross linking if desired. Cross linking, or cross friction, can be as a result of friction, lateral projecting interfering members, or bonding.

Ply-veneer is a thin version of ply wood. In Ply wood, alternate layers of wood are bonded or glued together with each succeeding layer having its grain situated at an angle, preferably perpendicular, to the next most adjacent layer, although angularity less than perpendicularity if possible. It will be understood that ply-veneer or woven veneer may have a variety of thicknesses. The number of layers and weaves of such material permitted will depend upon their contribution to the slat into which they will be incorporated.

Metals which can be used include thin steel, aluminum, titanium, or any other material having the ability to impart a strength to the veneer layers 31 and 35 lying on either side. The ability of the metal or indeed any material of the bonding core layer 39 to bond to the layers of veneer 31 and 35 is important. The bonding of the core layer 39 to the layers of veneer 31 and 35 can be accomplished with any type of glue or adhesive which will give good non-separating results, and may depend upon the materials chosen for the core layer 39 and layers of veneer 31 and 35. The core layer 39 can have a thickness of from about 0.15 mm to about 0.3 mm. For metals, this number might be a simple, uniform material thickness. For a non-woven, or cloth, or ply veneer or woven veneer, or fiber based core layer 39, this thickness might be the final thickness after heating and pressing. Heating and pressing and other curing or final bonding steps may help produce an improved tensile strength through forced thickness reduction during processing.

As a result, the potential thickness of the final slat will depend upon which materials are used, how many layers are used and how the core layer 39 is constructed. At the extreme lower dimensions, where the core layer 39 is made from a paper-thin non-woven material, it may be as low as 0.1 mm, but it is believed that 0.15 mm is necessary to impart some lower acceptable strength. For thicker slats, the core layer 39 (as well as other core-type layers shown in subsequent Figures) may even approach 1.0 mm for a thicker slat. Where the core layer approaches 1.0 mm, the resulting slat may preferably be 3.0 mm or thicker.

Further, the thickness of the veneer layers 31 and 35 may also depend upon a number of other factors, including the ability to cut and handle the veneer layers 31 and 35, as well as the needed thickness of the veneer layers 31 and 35 for adequate color appearance. The color appearance of the combination of the core layer 39 and the veneer layers 31 and 35 will combine to affect the thickness of the veneer layers 31 and 35 necessary to produce an acceptable result. As in the Figures following FIG. 1, the final thickness of the resulting slat 21 will depend upon the thicknesses of material used with a judicious selection of such materials to make an acceptable appearing slat 21.

The thickness of the lacquer layers 23, 25, 27, and 29 may be so thin as to be negligible. In some examples, however an effect can be produced by a thicker layer of lacquer, but this should only occur in some types of effects for certain types of window coverings, much like table tops which are over lacquered to produce a three dimensional effect. However, this type of effect is not desired where the goal is to produce the lightest slat 21 possible.

The finish of the upper finished surface 33 and lower finished surface 37 can be formed either before or after the layers of veneer 31 and 35 are bonded to the core layer 39. In practice, and especially where the core layer 39 is to have a shape, the layers of veneer 31 and 35 can be added before or after the core layer 39 is shaped or bonded in the same step in which the core material 39 is shaped, such as in a press die or similar.

The steps for formation, in any order, are to provide layers of veneer 31 and 35, finish their upper finished surface 33 and lower finished surface 37, bond the layers of veneer 31 and 35 to the core layer 39, shape the core layer 39 if necessary, and lastly to apply a surrounding layer of lacquer to form lacquer layers 23, 25, 27, and 29 to seal the resulting slat 21. Pressure, heat, and other environmental aspects may be applied, especially during the bonding step, in order to work with the glues or adhesives present.

The slat 21 opens the possibility for other combinational processing steps. Sheets of the bonding core layer 39 may be bonded to sheets of veneer, and then finished, before being cut into the slat 21 shape. Shaping of the core layer 39 can occur at any time due to the superior bond formed between the core layer 39 and the upper and lower veneer layers 31 and 35. Shaping of a core layer 39 can be done by bending, such as over bending to use Young's modulus for a stable spring back effect, or the shape can be formed based upon heat and pressure in a die or other holding device, which will cause the core layer 39 to achieve a stable shape after such processing.

The use of a core material with fibrous tensile qualities is important in holding together the upper and lower veneer layers 31 and 35. This is especially true where wood grain upper and lower veneer layers 31 and 35 have a grain which is longitudinal to the extent of the slat 21 and would tend to exacerbate the splintering effect of each on bending. The core layer 39 provides close attachment, along with isolation of any deleterious synergy from having grain oriented in the same direction.

Other combinational possibilities are also shown, with general spatial equivalence to previously shown layers being illustrated with the same numbering. Referring to FIG. 2, a perspective exploded view of the end of a short length of slat 31 utilizes a pair of core layers, including an upper core layer 53 and a lower core layer 55. The use of two core layers of either woven or non-woven material gives an opportunity for further strengthening without much expense in terms of adding to the thickness or weight. For example, where upper core layer 53 may have a fibrous structure which is predominantly oriented in one direction, the lower core layer 55 may have a fibrous structure oriented in an orthogonal direction. These directions need not necessarily be oriented along or perpendicular to the length of any resulting slat 31. In some cases, and depending upon the glue or adhesive 41 used, the bonding of a pair of core layers 53 and 55 can produce a “composite” core which is even stronger. The remainder of the slat 21 is similar to that seen in FIG. 1.

Referring to FIG. 3, a perspective exploded view of the end of a short length of slat 61 material with exploded lacquer layer with an upper layer of veneer 31 and an underlying layer 63 having a lower surface 65. As stated above, it is generally not favored to have two layers of veneer attached to each other, but it is possible. Further, the underlying layer 63 can be any of a number of other materials. Underlying layer 63 can be metal, to support the upper layer of veneer 31, it can be a simple layer of wood with a lower surface 65 which is painted, it can be a lower sheet of veneer such as lower veneer layer 35, it can be a wooden layer having grains which are perpendicular to the grains of the upper layer of veneer 31, and a further variety of materials. In some window coverings and horizontal blinds it is desired to have one side of a slat such as slat 61 to have a finish different than the finish of the upper finished surface 33. The use of an underlying layer 63 of reflective metal could produce a cooling effect by re-radiating visible light back through the window. Conversely, an underlying layer 63 which is black could help turn incident light into heat by heating of the slat 61. When it is remembered that the upper veneer layer 31 can range in color from dark wood finish to a bright very light wood finish it can be seen that the upper surface can be light and the lower surface can be dark, and vice versa.

FIG. 3 illustrates the simplest construction and perhaps therefore the lightest. The use of an underlying layer 63 to give brightness variation can be important and useful. Slat 61 can be particularly useful where the lower surface 65 can be made to be decorative or reflective or have some other useful characteristic. An underlying layer 63 made of polished metal on its lower surface 65, with a roughened upper surface for bonding to the underside of the upper veneer layer 31 would be one good combination.

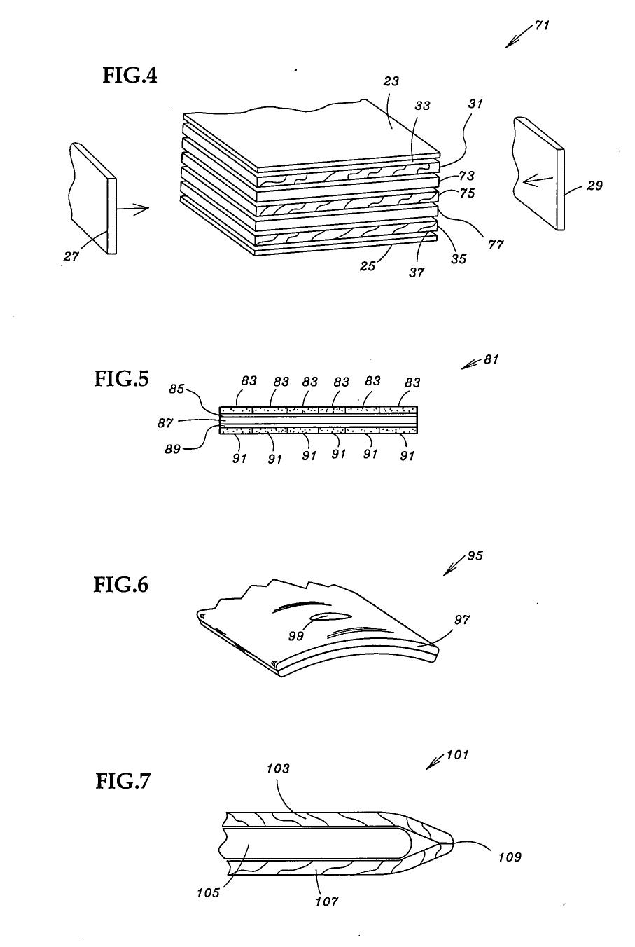

Referring to FIG. 4, a slat 71 is shown has having a series of three additional core layers between the upper and lower veneer layers 31 and 35, namely core layers 73, 75, and 77. Although the addition of more core layers may add somewhat to the weight, the use of additional core layers can contribute to formation of a stiff, very strong slat 71.

Further, it may also be preferable for core layers 73 and 77 to be made from a non-woven or woven cloth or other material, with core layer 75 preferably being a non-decorative or low quality veneer. In this configuration, the core layer 75 as a veneer layer 75 would not need to have high quality as it would not be seen. This opens the possibility of using a scrap wood material having a grain which runs across the shorter dimension of the slat 71 which might be able to give additional strength without sacrificing flexibility.

Other possibilities for the core layers 73, 75 and 77 include the use of a cloth or non-woven for all three. However, it is believed that the best combination is having core layers 73 and 77 made of a fibrous material such as cloth or woven or non-woven material, with core layer 75 being a thin, scrap quality veneer.

Referring to FIG. 5, a plan view of the end of a bamboo embodiment of the composite slats shown in FIGS. 1-4, but emphasizing the generally uniform lateral profile of bamboo assemblies. In a related case, U.S. patent Ser. No. 11/529,971; which is incorporated by reference herein, it was shown and described and illustrated in detail how long strips are cut from bamboo culm, boiled in water to cause the bamboo material in the strips to relax, so that they can be pressed flat. The radially arc shaped strips come to have a trapezoidal cross section and are then typically cut into a rectangular square. The exterior of the bamboo is then sanded or planed to produce a bamboo finished surface, either before or after the strips are joined to other strips, to a substrate of different material. The hallmark of bamboo veneer or bamboo boarding is the provision of strips which are close fitting and of uniform width.

FIG. 5 illustrates an end view of an assembled bamboo slat 81 made in a way in which the bamboo strips have uniform width and generally oppose each other. From the top, the ends of an upper row of bamboo strips 83 are seen. The bamboo strips 83 are attached to each other and to a first core layer 85 of woven or non woven fibrous material. A central core layer 87 can be made of the same materials as were mentioned for bonding core layer 39, including metal, wood veneer (scrap), composite carbon, and more.

Under the central core layer 87, a second core layer 89 of woven or non woven fibrous material is seen. Under the second core layer 89 a lower row of bamboo strips 91 are seen. The result is a slat 81 having a bamboo finish on both sides. Where the central core layer 87 is either bendable or capable of being formed as a non-flat shape, the slat 81 can be shaped accordingly.

The configuration of FIG. 5 is just one of many configurations, with some other structural configurations seen in U.S. patent Ser. No. 11/529,971. Where the thickness of the bamboo strips 83 become very thin, the perpendicular quality of their matching adjacent surfaces begins to diminish and the result can be a very thin slat 81. Where the core layer 87 is made of thin metal, a very thin bamboo slat 81 results. Very thin bamboo can be easily formed and bent, particularly when it is wet or hot. As was described in the above patent, since the bamboo strips 83 and 91 were initially formed from arc pieces of material, it is an easy matter to alter the final formation steps where it is needed to make a thick, shaped slat. The steps of construction of the slats herein can be modified to replace any of the veneer layers with very thin layers of bamboo.

Further, the manner in which bamboo is made and used, by forming strips, is amenable to the process and layers described by making a slight modification in the order of processing. The bamboo strips 83 can be formed onto first core layer 85 in a separate operation. This can involve a sheet of bamboo strips if varying length and offset from each other which can be kept flat and continue to be processed, sanded, planed, etc. The same is true for the bamboo strips 91 to form the lower layer. Then the upper and lower layer assemblies of the bamboo strips 83 and their core layer 85, as well as the bamboo strips 91 and their core layer 89 can be then bonded onto central core layer 87. In some cases, any shaping may be done under any stage of processing and preferably under high pressure to insure that the widths of the bamboo strips 83 and 91 bend adequately across their width and do not produce protrusions at their interfaces. Further sanding or planing might be in order for curved slats. Again, although not shown, the lacquer layers 23, 25, 27, and 29 would be applied to the completed bamboo slat 81.

Referring to FIG. 6, a perspective end view of a curved slat 95 formable with any of the structures and techniques shown herein, is illustrated. Some layering appearance may occur at an end 97, especially where the end 97 is not painted or where the end 97 is cut, but the remainder of the slat 95 will appear as if it is made of a unitary material. A lift cord aperture 99 is also seen.

Referring to FIG. 7 an illustration of the advantage of using veneer is seen. A slat 101 is shown without lacquer layers 23, 25, 27, and 29, and is seen as having an upper veneer layer 103 a core layer 105 and a lower veneer layer 107. Note that the core layer 105 stops just short of the extent of the lateral extent of the upper veneer layer 103 and the lower veneer layer 107. Due to the fact that the core layer 105 stops short, and especially where pressure and adhesive is used, the upper veneer layer 103 naturally extends and is attached to the lower veneer layer 107 to form a very slight double veneer termination. Because these layers are bonded together, they present twice the thickness of veneer at the edge and can be easily finished to an edge which is essentially twice the thickness of the upper veneer layer 103 and the lower veneer layer 107. Since the finishing forces are applied laterally with respect to the view of FIG. 7, and because the core layer 105 terminates only very slightly earlier than the upper veneer layer 103 and the lower veneer layer 107, good structural support is had and separation does not occur under normal finishing. Finishing after formation will most likely involve some blend sanding to remove the upper and lower square corner which might otherwise occur with a square sheet of veneer if such is used for the upper veneer layer 103 and the lower veneer layer 107. The result is a smooth edge 109 where the dividing line between the upper veneer layer 103 and the lower veneer layer 107 cannot be seen.

While the present invention has been described in terms of a system and method for forming of various constructions of slats from various layers of wood veneer and thin strips of bamboo, as well as a wide variety of core materials, one skilled in the art will realize that the structure and techniques of the present invention can be applied to many structures, including any structure or technique where joinder with enhanced contact structures for slat formation with veneer and bamboo, both for appearance and for inexpensive structural reinforcement.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A slat for a window covering comprising:
an upper veneer layer having a first finished surface and a second surface;
a lower veneer layer having a first finished surface and a second surface;
a bonding core layer having a first surface bonded to said second surface of said upper veneer layer, and a second surface bonded to said second surface of said lower veneer layer.

2. The slat for a window covering as recited in claim 1 wherein at least one of said upper veneer layer and said lower veneer layer is comprised of strips of bamboo.

3. The slat for a window covering as recited in claim 1 wherein at least one of said upper veneer layer and said lower veneer layer is bonded to said bonding core layer using at least one of a glue and an adhesive.

4. The slat for a window covering as recited in claim 1 wherein said bonding core layer is at least one of a cloth and a non-woven expanse of material.

5. The slat for a window covering as recited in claim 1 wherein said bonding core layer is metal.

6. The slat for a window covering as recited in claim 1 wherein said bonding core layer is further comprised of two bonding core layers which are attached to each other.

7. The slat for a window covering as recited in claim 6 wherein said bonding core layer is at least one of a cloth and a non-woven expanse of material.

8. The slat for a window covering as recited in claim 1 wherein said slat is surrounded by an acrylic lacquer for sealing said slat from moisture.

9. The slat for a window covering as recited in claim 1 wherein said bonding core layer is further comprised of:
a first layer of at least one of a cloth and a non-woven expanse of material;
a thin scrap veneer layer of wood having a first side attached to said first layer of at least one of a cloth and a non-woven expanse of material, and a second side; and
a second layer of at least one of a cloth and a non-woven expanse of material attached to said second side of said thin scrap veneer layer.

10. A slat for a window covering comprising:
an upper veneer layer having a first finished surface and a second surface;
an underlying layer having a first surface bonded to said second surface of said upper veneer layer; and wherein said slat is surrounded by an acrylic lacquer for sealing said slat from moisture.

11. The slat for a window covering as recited in claim 10 wherein said upper veneer layer is comprised of strips of bamboo.

12. The slat for a window covering as recited in claim 10 wherein said upper veneer layer is bonded to said underlying layer using at least one of a glue and an adhesive.

13. The slat for a window covering as recited in claim 10 wherein said underlying layer is at least one of a cloth and a non-woven expanse of material.

14. The slat for a window covering as recited in claim 10 wherein said underlying layer is metal.
